(19) United States
(12) Patent Application Publication
(10) Pub. No.: US 2016/0103431 A1
(43) Pub. Date: Apr. 14, 2016

(54) SYSTEM AND METHOD FOR POINT BY POINT HOT CUTOVER OF CONTROLLERS AND IOS

(71) Applicant: Honeywell International, Inc., Morristown, NJ (US)

(72) Inventors: Ramakrishnan Ganapathi, Bangalore (IN); Ananthapadmanabha Krishnamurthy, Bangalore (IN); Mandar Gajanan Bagade, Pune (IN); Rajani Keerthiveetil, Bangalore (IN)

(21) Appl. No.: 14/514,129

(22) Filed: Oct. 14, 2014

(51) Int. Cl. G05B 11/01; G05B 15/02

(52) U.S. Cl. CPC G05B 11/011; G05B 15/02

(57) ABSTRACT

A method includes translating at least one control strategy associated with a first controller into an equivalent translated control strategy compatible with a second controller, where the first and second controllers represent controllers in an industrial process control and automation system. The method also includes selecting one or more spare locations on the second controller to configure one or more corresponding points. The method further includes loading the at least one translated control strategy into a control environment associated with the second controller. In addition, the method includes moving a slot configuration of each of the one or more points from the first controller to the second controller.

### TECHNICAL FIELD

This disclosure relates generally to industrial process control and automation systems. More specifically, this disclosure relates to a system and method for point-by-point hot cutover of controllers and inputs/outputs (IOs).

### BACKGROUND

Industrial process control and automation systems are often used to automate large and complex industrial processes. These types of control and automation systems routinely include sensors, actuators, and controllers. The controllers typically receive measurements from the sensors and generate control signals for the actuators.

If an existing legacy controller in a control and automation system is approaching its “end of life,” a new type of controller may need to be installed in the system. However, if the new type of controller is considerably different from the legacy controller being replaced, installing the new type of controller may require significant modifications to higher-level controllers, human-machine interfaces, or other components.

One prior approach to switching controllers involves performing a cutover of one or more legacy devices connected to an old network to replacement devices connected to a new network. This approach requires an industrial facility (or a portion thereof) to be shut down for a period of time. This approach may also require replacement of custom-created user interfaces and control applications used with the legacy devices. This can impose significant monetary losses on the facility's operators.

### SUMMARY

This disclosure provides a method and system for a point-by-point hot cutover of one or more controllers and inputs/outputs (IOs).

In a first embodiment, a method includes translating at least one control strategy associated with a first controller into an equivalent translated control strategy compatible with a second controller, where the first and second controllers represent controllers in an industrial process control and automation system. The method also includes selecting one or more spare locations on the second controller to configure one or more corresponding points. The method further includes loading the at least one translated control strategy into a control environment associated with the second controller. In addition, the method includes moving a slot configuration of each of the one or more points from the first controller to the second controller.

In a second embodiment, an apparatus includes a first interface configured to communicate with a first controller in an industrial process control and automation system and a second interface configured to communicate with a second controller in the industrial process control and automation system. The apparatus also includes at least one processing device configured to select one or more spare locations on the second controller to configure one or more corresponding points and translate at least one control strategy associated with the first controller into an equivalent translated control strategy compatible with the second controller. The at least one processing device is also configured to load the at least one translated control strategy into a control environment associated with the second controller and move a slot configuration of each of the one or more points from the first controller to the second controller.

In a third embodiment, a non-transitory computer readable medium embodies a computer program. The computer program includes computer readable program code for translating at least one control strategy associated with a first controller into an equivalent translated control strategy compatible with a second controller, where the first and second controllers represent controllers in an industrial process control and automation system. The computer program also includes computer readable program code for selecting one or more spare locations on the second controller to configure one or more corresponding points. The computer program further includes computer readable program code for loading the at least one translated control strategy into a control environment associated with the second controller. In addition, the computer program includes computer readable program code for moving a slot configuration of each of the one or more points from the first controller to the second controller.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example migration from legacy devices to new devices in an industrial process control and automation system in accordance with this disclosure;

FIGS. 2 through 4 illustrate an example gateway supporting migration from legacy devices to new devices and related details in accordance with this disclosure;

FIG. 5 illustrates an example method for performing a point-by-point hot cutover from a legacy device to a new device in accordance with this disclosure; and

FIGS. 6A through 6D illustrate example system and corresponding operator graphical views at different points in time during a point-by-point hot cutover in accordance with this disclosure.

### DETAILED DESCRIPTION

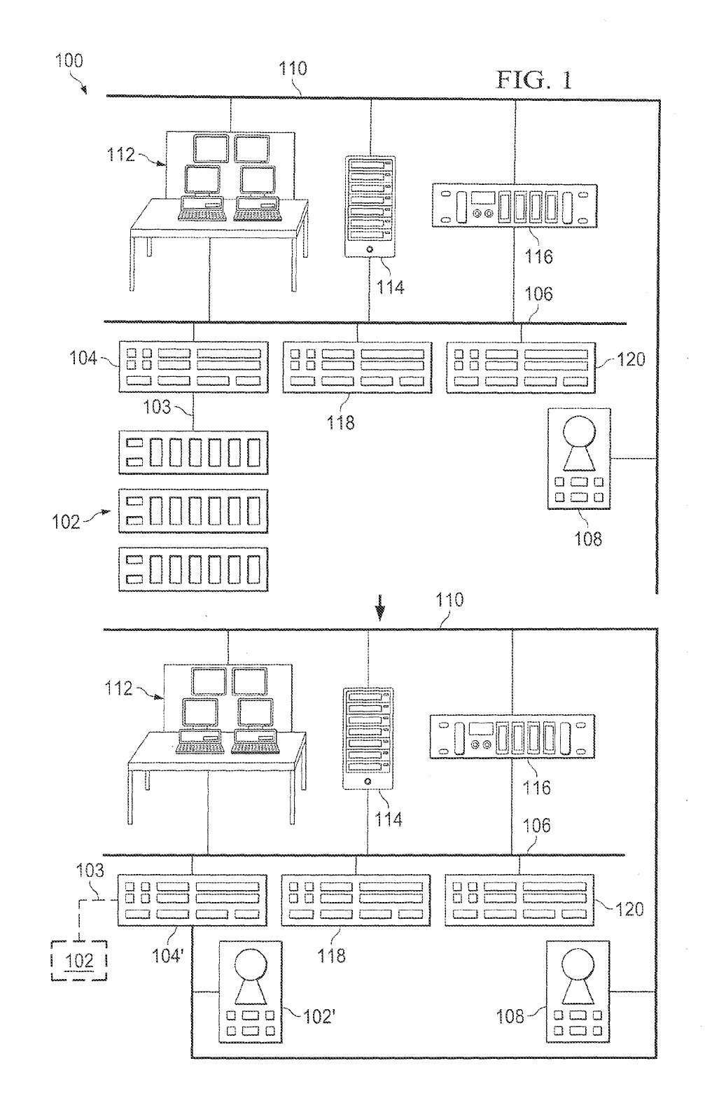

FIGS. 1 through 6D, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

In the following description, procedures for migration or “cutover” from legacy devices to new devices using a migration gateway are described. A “legacy” device refers to a device being replaced by a more recent, more advanced, or other device. A “legacy” protocol refers to a protocol used by a legacy device, a “legacy” interface refers to an interface that supports the use of a legacy protocol, and a “legacy” network refers to a network that supports the use of a legacy protocol. A “new” or “advanced” device refers to a device that is replacing a legacy device. An “advanced” protocol refers to a protocol used by a new or advanced device, an “advanced” interface refers to an interface that supports the use of an advanced protocol, and an “advanced” network refers to a network that supports the use of an advanced protocol. Note that the terms “migration,” “cutover,” and “replacement” (and their derivatives), when used with reference to a legacy device, include both a physical replacement of the legacy device with a new or advanced device and an upgrade of the legacy device to have one or more features of a new or advanced device.

A “hot” cutover of a legacy device or system to a new device or system allows users to use custom and other displays, supervisory applications, history applications, and other applications as they are. In many systems, such a hot cutover can be a significant logistical challenge. In accordance with this disclosure, a hot cutover can be achieved by moving control loops from a legacy device, point-by-point, to a new device on-process. More specifically, field device connections are moved from a legacy control system under migration to a new control system point-by-point. The disclosed cutover procedures enable system users to view and control processes from an existing control system during and after cutover. During cutover, control functions of other control loops remain undisturbed. The disclosed procedures also enable the distribution of control loops across legacy and new control environments while providing a unified view to an operator. Any existing custom functions, including graphical functions, can access process and control data from both physical and emulated points.

The disclosed procedures provide consistent user access to a control system all through the cutover using existing displays and user operation environments. This reduces or eliminates the need for new operation environments and associated operator training prior to cutover and promotes continuous operation post-cutover. Likewise, no total system-wide shut down may be required for the cutover, so there may be no associated loss of production. Accordingly, the disclosed procedures provide a hot cutover that is fast, economical, and simple. The procedures can be applied suitably for graphic-by-graphic or unit-by-unit hot cutovers.

Although the migration procedures are often described below as the replacement of legacy process controllers with new or advanced process controllers in a process control and automation system, such procedures are not limited to use with just process controllers. Rather, the migration procedures can be used with any number(s) and type(s) of legacy devices being replaced with any number(s) and type(s) of new or advanced devices. Other example types of legacy devices that could be replaced with advanced devices include input/output (IO) devices. Also, as a specific example of this functionality, some migration procedures are described below as supporting the replacement of HIWAY-compliant devices with EXPERION-compliant devices, as well as the optional use of an emulated HIWAY protocol over a FAULT TOLERANT ETHERNET (FTE) network (HIWAY, EXPERION, and FAULT TOLERANT ETHERNET were developed by HONEYWELL INTERNATIONAL INC. or its subsidiaries). These specific protocols are examples only. The migration procedures disclosed in this patent document generally support the replacement of any suitable legacy devices with any suitable new or advanced devices. Moreover, the migration procedures disclosed in this patent document could optionally support the emulation of any suitable legacy protocol over an Internet Protocol (IP)-based network or other advanced network.

FIG. 1 illustrates an example migration from legacy devices to new devices in an industrial process control and automation system 100 according to this disclosure. As shown in FIG. 1, the system 100 includes one or more legacy controllers 102, which are often said to reside within or form a part of a “Level 1” controller network in a control and automation system. Each legacy controller 102 is capable of controlling one or more characteristics in an industrial process system. A process system generally represents any system or portion thereof configured to process one or more products or other materials in some manner. For instance, the legacy controllers 102 could receive measurements from one or more sensors and use the measurements to control one or more actuators. Each legacy controller 102 represents a controller to be replaced in the system 100.

The legacy controllers 102 communicate via a legacy network 103 with at least one legacy gateway 104. The legacy network 103 represents one or more communication paths that support interactions with the legacy controllers 102 using a legacy protocol. In some embodiments, the legacy network 103 could represent a coaxial network, such as a HIWAY network. However, the legacy network 103 could represent any other suitable legacy industrial process control network.

The legacy controllers 102 communicate with higher-level devices and systems via the legacy gateway(s) 104. In this example, each legacy gateway 104 facilitates communication between the legacy network 103 and a supervisory network 106, such as a local control network (LCN). Each legacy gateway 104 includes any suitable structure facilitating communication with one or more legacy devices via a supervisory network. The supervisory network 106 represents a network facilitating communication among higher-level process control and automation devices and systems.

In particular embodiments, the legacy controllers 102 represent HIWAY controllers and PROCESS INTERFACE UNIT (PIU) devices, such as TDC2000 devices from HONEYWELL INTERNATIONAL INC. These types of devices routinely communicate over a “data hiway,” which uses the HIWAY protocol supported by the legacy gateway 104. The legacy gateway 104 converts between that protocol and the protocol used by the supervisory network 106.

The system 100 also includes one or more advanced controllers 108 that communicate over an advanced control network 110. The advanced controllers 108 represent controllers that are newer, more technologically advanced, or more feature-rich that the legacy controllers 102. Similarly, the control network 110 could represent a newer, more technologically advanced, or more feature-rich network for transporting control information, such as an IP-based network. In particular embodiments, the advanced controllers 108 could represent C300 controllers from HONEYWELL INTERNATIONAL INC., and the control network 110 could represent an FTE or other redundant IP-based network.

Various other components in the system 100 support a wide range of process control and automation-related functions. For example, one or more operator consoles 112 can be used by operators to interact with the system 100. At least one supervisory controller 114 and at least one server 116 provide higher-level control in the system 100. For instance, the supervisory controller 114 and/or server 116 could perform more advanced planning or scheduling operations, execute higher-level control strategies, or perform other functions. At least one application processing platform 118 can be used to automate various procedures in the system 100. At least one historian 120 can be used to collect and store data associated with operation of the system 100 over time. Various ones of these components are often said to reside within or form a part of a “Level 2” supervisory network in a control and automation system.

Each operator console 112 includes any suitable structure for facilitating operator interactions, such as an EXPERION STATION TPS from HONEYWELL INTERNATIONAL INC. Each controller 114 includes any suitable structure for providing supervisory control, such as an APPLICATION CONTROL ENVIRONMENT-TPS (ACE-T) node from HONEYWELL INTERNATIONAL INC. Each server 116 represents any suitable computing device, such as an EXPERION SERVER TPS from HONEYWELL INTERNATIONAL INC. (or a redundant pair of such servers). Each application processing platform 118 includes any suitable structure for executing automated procedures, such as an APPLICATION MODULE (AM) from HONEYWELL INTERNATIONAL INC. Each historian 120 includes any suitable structure for storing data, such as a HISTORY MODULE (HM) from HONEYWELL INTERNATIONAL INC.

As shown in FIG. 1, the legacy controllers 102 are being replaced with advanced controllers 102′. This could occur, for instance, when the legacy controllers 102 have reached their “end of life” and are no longer supported by a vendor or manufacturer. Moreover, the legacy gateway 104 is being replaced with a junction gateway 104′, which supports the migration from the legacy controllers 102 to the advanced controllers 102′.

One conventional approach to replacing legacy controllers is “rip and replace,” where a facility or portion thereof is simply shut down and the legacy controllers are replaced with new controllers. However, this approach requires facility down-time and associated monetary losses. Moreover, legacy controllers 102 are often managed using higher-level components, such as the application processing platform 118 that typically implements a large number of procedures involving the legacy controllers 102. As a result, simply replacing the legacy controllers 102 would require large amounts of work to update the procedures executed by the application processing platform 118 or to migrate those procedures to a supervisory controller 114. In addition, operators often interact with legacy controllers 102 via interfaces provided at the operator consoles 112. The “rip and replace” technique typically requires updating or replacing the interfaces supported by the operator consoles 112 and may actually require replacement of the entire supervisory network 106 and all connected devices.

The junction gateway 104′ supports an improved transition between the use of legacy controllers 102 and the use of advanced controllers 102′. As described in more detail below, the junction gateway 104′ can be connected to both the legacy controllers 102 (via the legacy network 103) and the advanced controllers 102′ (via the control network 110). This allows the legacy controllers 102 to remain online and operational while the advanced controllers 102′ are installed, commissioned, and brought online. Once the advanced controllers 102′ are ready for operation, control of a process system can be transferred from the legacy controllers 102 to the advanced controllers 102′. This helps to avoid shutting down part or all of a process system and allows operators to verify that the advanced controllers 102′ are operating correctly prior to placing them into active control operation.

The junction gateway 104′ may also emulate or otherwise support at least one legacy protocol over the control network 110. For example, the junction gateway 104′ could be configured to emulate the HIWAY protocol used by legacy controllers 102 over an FTE or other advanced control network 110. This allows some higher-level devices (such as the components 118-120) to interact with the advanced controllers 102′ via the gateway 104′ as if the advanced controllers 102′ support the legacy protocol(s) used by the legacy controllers 102. This also allows other higher-level devices (such as the components 112-116) to interact with the advanced controllers 102′ via the network 110 without using the gateway 104′. As a particular example, the junction gateway 104′ can receive requests from higher-level devices, scatter the requests to the advanced controllers 102′, gather responses that are in a format compliant with a legacy protocol, and submit compiled responses to the higher-level devices.

Using these techniques, the junction gateway 104′ allows legacy controllers 102 to be replaced with advanced controllers 102′ without requiring a shutdown of part or all of an industrial process system. Moreover, the junction gateway 104′ allows the advanced controllers 102′ to be installed, commissioned, and tested without interfering with the control operations of the legacy controllers 102, allowing the advanced controllers 102′ to be brought online without interrupting the control of the process system. Further, the junction gateway 104′ could allow the advanced controllers 102′ to be used with both higher-level components that still use the legacy protocol and higher-level components that use an advanced protocol. This could reduce or avoid the need to update or migrate procedures executed by the application processing platform 118 and the interfaces supported by the operator consoles 112.

In addition, using these techniques, it is possible to “decouple” the replacement of the legacy controllers 102 from the replacement of components such as Level 2 devices or systems. As a result, the Level 2 devices or systems can be replaced at the same time as or at a different time than the legacy controllers 102. For example, most or all Level 2 devices or systems can continue operations with the advanced controllers 102′ and can be replaced as fast or as slow as desired. This can help to reduce the cost of replacing the legacy controllers 102 and allow expenses to be distributed over a greater length of time.

Although FIG. 1 illustrates one example of a migration from legacy devices to new devices in an industrial process control and automation system 100, various changes may be made to FIG. 1. For example, various components in FIG. 1 could be combined, further subdivided, moved, or omitted and additional components could be added according to particular needs. Also, the system 100 could include any number of each component shown in FIG. 1. Control and automation systems come in a wide variety of configurations, and FIG. 1 does not limit the scope of this disclosure to any particular configuration. In addition, the components 112-120 shown in FIG. 1 are only examples of the types of higher-level components that might be present in a system and interact with legacy controllers 102 and advanced controllers 102′. Other or additional higher-level components could also be used.

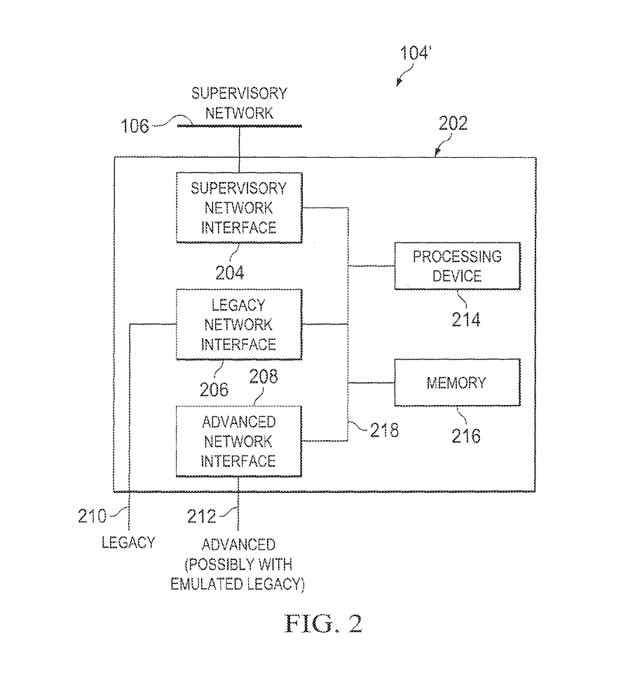

FIGS. 2 through 4 illustrate an example gateway 104′ supporting migration from legacy devices to new devices and related details according to this disclosure. For ease of explanation, the gateway 104′ in FIGS. 2 through 4 is described as being used in the system 100 of FIG. 1. The gateway 104′ could be used in any other suitable system to support migration from any suitable legacy devices to any suitable advanced devices.

As shown in FIG. 2, the gateway 104′ includes a housing 202. The housing 202 generally denotes a structure that protects, encases, or holds other components of the gateway 104′. The housing 202 includes any suitable structure in which other components of a gateway can be placed. The housing 202 could also be formed from any suitable material(s) and in any suitable manner. In particular embodiments, the housing 202 includes a chassis into which printed circuit board (PCB) cards can be inserted and coupled to a backplane or other structure.

The gateway 104′ also includes three interfaces 204-208. The interface 204 supports communication over a supervisory network 106. For example, the interface 204 can receive data from and transmit data to various components 112-120 coupled to the supervisory network 106 using at least one standard or proprietary protocol.

The interface 206 supports communication over a legacy communication link 210, which could be coupled to the legacy network 103. The legacy communication link 210 represents a communication link used to communicate with one or more legacy controllers 102. In particular embodiments, the legacy communication link 210 supports communication with HIWAY controllers and PIU devices.

The interface 208 supports communication over an advanced communication link 212. The communication link 212 could represent a communication link used to communicate over the advanced control network 110, and those communications can optionally be made via an emulation of the legacy protocol used by legacy controllers 102 (although this is not necessarily required). In particular embodiments, the communication link 212 supports communication using an emulated HIWAY protocol over an FTE or other IP-based network.

Among other things, the gateway 104′ can translate between the protocols used by the supervisory network 106, the control network 110, and the legacy network 103. This allows the legacy controllers 102 to be used while the advanced controllers 102′ are being installed, commissioned, and brought online. This can optionally allow communications to and from the advanced controllers 102′ using the emulated protocol, so higher-level devices that still use or rely on the legacy protocol can continue to interact with the advanced controllers 102′.

The gateway 104′ also includes at least one processing device 214 and at least one memory 216. The processing device 214 controls the overall operation of the gateway 104′. For example, the processing device 214 could control the operations of the interfaces 204-208 to thereby control the transmission and reception of data by the gateway 104′. The processing device 214 could also support any translations or other operations needed to support the flow of data between different interfaces 204-208. For instance, the processing device 214 can determine how specific controllers are to be contacted and initiate communications to and from the controllers via the appropriate interfaces 206-208. As a particular example, the processing device 214 can support the “scattering/gathering” of requests and responses, meaning the processing device 214 can transmit (scatter) requests to one or multiple devices (legacy and/or advanced devices), collect (gather) responses to the requests, and combine the responses into a suitable format for transmission over the supervisory network 106.

The processing device 214 includes any suitable structure for performing or controlling operations of a gateway, such as one or more processing or computing devices. As particular examples, the processing device 214 could include at least one microprocessor, microcontroller, digital signal processor, field programmable gate array, application specific integrated circuit, or discrete logic device.

The memory 216 stores instructions or data used, generated, or collected by the gateway 104′. For example, the memory 216 could store software or firmware instructions executed by the processing device 214. The memory 216 could also store data received via one interface 204-208 that is to be transmitted over another interface 204-208. The memory 216 includes any suitable volatile and/or non-volatile storage and retrieval device(s), such as at least one random access memory and at least one Flash or other read-only memory.

In particular embodiments, the interface 204 could represent a K4LCN interface card from HONEYWELL INTERNATIONAL INC., with modifications made to the firmware of the card to support appropriate interactions over the supervisory network 106. The processing device 214 and the memory 216 could reside on the K4LCN interface card. Also, in particular embodiments, the interface 206 could represent a DATA HIGHWAY INTERFACE (DHI) card from HONEYWELL INTERNATIONAL INC. Further, in particular embodiments, the interface 208 could represent an interface card with firmware designed to emulate the HIWAY protocol over an FTE or other IP-based network, which could be known as an ENHANCED HIWAY BRIDGE INTERFACE (EHBI).

A bus 218 supports communications between other components of the gateway 104′, such as the interfaces 204-208, the processing device 214, and the memory 216. The bus 218 represents any suitable communication path(s) for transporting data or other signals in a gateway.

By providing both the interfaces 206-208, the gateway 104′ is able to support communications over both a legacy network 103 and an advanced control network 110. Moreover, by using the single interface 204, the gateway 104′ is able to present itself as a single logical HIWAY device (or a device compliant with another legacy protocol) on the supervisory network 106. Thus, the gateway 104′ enables communications with both legacy controllers 102 and advanced controllers 102′ while still appearing as an appropriate device on the supervisory network 106 to higher-level components.

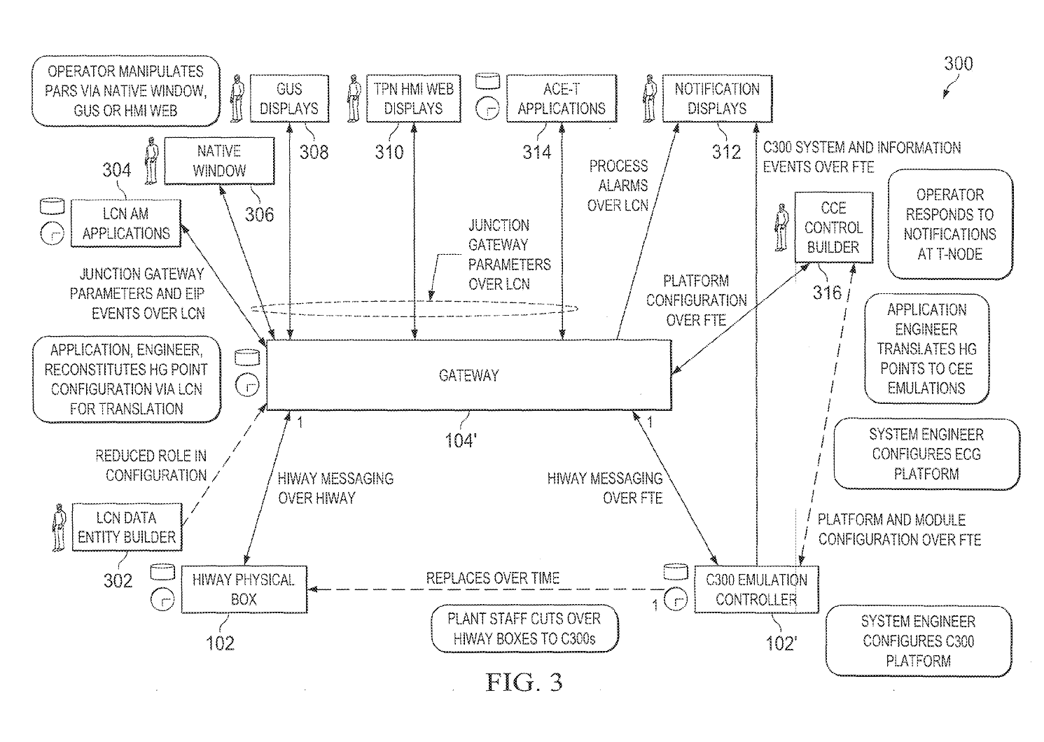

FIG. 3 illustrates one example usage of the gateway 104′. In FIG. 3, rectangles are used to denote subsystems of a control and automation system 100. Solid lines indicate data/information flows between subsystems, and dashed lines indicate logical relationships between subsystems. Ovals represent example use cases, meaning example ways in which the gateway 104′ could be used. In this particular example, the legacy devices being replaced represent HIWAY devices, the advanced devices represent C300 controllers, and the network 110 represents an FTE network. This is for illustration only, and other type(s) of controllers and networks could be used.

In FIG. 3, an LCN data entity builder (DEB) 302 represents an application used to configure and manage legacy controllers 102, such as to perform engineering configurations on the legacy controllers. Components 304-314 represent subsystems of the system 100 that can interact with the gateway 104′ over the supervisory network 106. Applications 304 denote applications that could be executed on an APPLICATION MODULE or other application processing platform 118. Native windows 306, global user station (GUS) displays 308, HMIWEB displays 310, and notification displays 312 represent applications that present displays to operators via different types of operator consoles 112. The displays 306-310 can be used by operators to make changes to certain variables associated with a process system, and the display 312 can be used by operators to acknowledge or respond to various notifications. Applications 314 denote applications that could be executed on an ACE-T node or other supervisory controller 114.

A control builder 316 can be used to configure and manage the advanced controllers 102′. The control builder 316 can be used, for example, by one or more applications engineers to translate HIWAY GATEWAY (HG) control points into suitable control execution environment (CEE) emulations. The control builder 316 can also be used by one or more systems engineers to configure the interface 208 in the gateway 104′ and the advanced controllers 102′.

As shown in FIG. 3, different types of information can be exchanged between the components of FIG. 3 over different types of networks. For example, the gateway 104′ can exchange HIWAY messages with the legacy controllers 102 over the legacy network 103. The gateway 104′ can also exchange emulated HIWAY messages with the advanced controllers 102′ over the network 110. The gateway 104′ can further exchange gateway parameters, as well as event initiated processing (EIP) events, with the components 304-312 over the supervisory network 106. In addition, the gateway 104′ can exchange process alarms with the notification displays 312 and configuration data with the control builder 316 over the control network 110. Moreover, the advanced controllers 102′ can communicate events to the notification displays 312 and exchange configuration data with the control builder 316 over the control network 110.

As described above, one use of the gateway 104′ is to facilitate migration from the legacy controllers 102 to the advanced controllers 102′ without requiring a shutdown of part or all of an industrial process system. This can be accomplished using, among other things, concurrent access via the gateway 104′ to the legacy controllers 102 and the advanced controllers 102′. Moreover, the decoupling of the migration of Level 1 and Level 2 devices can be supported using, among other things, the emulation of a legacy protocol (such as a HIWAY protocol) by the gateway 104′ so that higher-level devices can continue operating under the assumption that the advanced controllers 102′ support the legacy protocol. As a result, Level 1 legacy devices (such as legacy controllers 102) can be migrated to advanced devices (such as advanced controllers 102′) without requiring much if any modifications to Level 2 components. The Level 2 components could be migrated at the same time as the Level 1 components, or any desired length(s) of time could elapse until the Level 2 components are migrated.

Moreover, the concurrent access to the legacy controllers 102 and the advanced controllers 102′ supports both fast and prolonged cutovers of the controllers. The use of the gateway 104′ allows the legacy controllers 102 to be used to control a process system while the advanced controllers 102′ are installed, commissioned, and tested. This can occur over a short period of time or a prolonged period of time depending on various factors. Once operation of the advanced controllers 102′ is determined to be satisfactory, the advanced controllers 102′ can be placed into control operation while the legacy controllers 102 are placed into standby mode. If the advanced controllers 102′ perform as expected, the legacy controllers 102 can be decommissioned and removed from the system. If the advanced controllers 102′ do not perform as expected, the legacy controllers 102 can be brought back into active operation.

In addition, it is possible for the migration of legacy controllers 102 to advanced controllers 102′ to occur incrementally, such as one legacy controller 102 or a subset of legacy controllers 102 at a time. Moreover, in accordance with this disclosure, the migration or cutover of a single legacy controller 102 to an advanced controller 102′ can be performed point-by-point. Thus, there may be times when both legacy controllers 102 and advanced controllers 102′ are performing control actions in the system 100. The gateway 104′ supports such incremental migration by helping to ensure that communications with both types of controllers can occur concurrently.

In this particular embodiment, the gateway 104′ supports the use of an emulated HIWAY protocol over an FTE control network 110. This can be done, for example, to communicate with the C300 advanced controllers 102′ via the control network 110. In this approach, the gateway 104′ emulates the use of the HIWAY protocol, but data is transported over the network 110 using IP-based data packets.

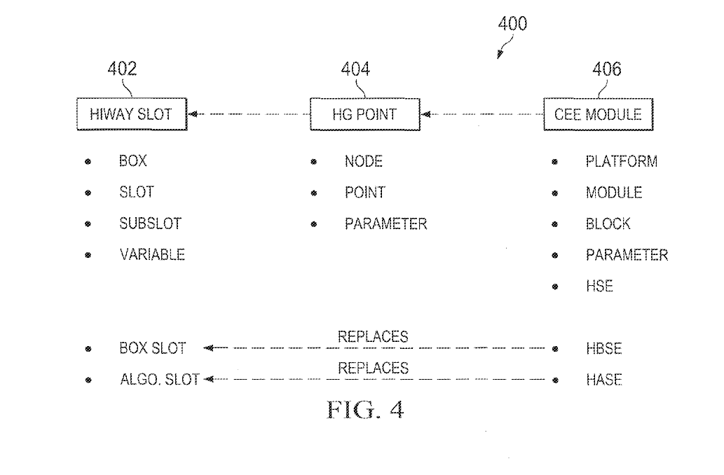

FIG. 4 illustrates example details related to emulating or otherwise supporting a legacy protocol. In particular, FIG. 4 illustrates example control protocols 402-406 used by different devices. The first protocol 402 is used by HIWAY devices (such as legacy controllers 102). A “box” refers to a particular device, a “slot” defines a particular memory location, a “subslot” can define a particular part of a slot, and a “variable” defines the value stored in the slot. A “box slot” refers to the logical grouping of all data resident within a legacy controller that describes box-wide properties rather than algorithm specific properties, and an “algorithm slot” refers to a particular algorithm that can be executed by a legacy controller.

The second protocol 404 is used by various supervisory devices. A “node” refers to a particular device, a “point” refers to a slot in the node, and a “parameter” (often referred to as “point.parameter”) refer to a particular value of the point in the identified device. The third protocol 406 is used by EXPERION devices. A “platform” refers to a particular device, and a “module,” a “block,” and a “parameter” refer to a particular value in the identified device.

Advanced controllers 102′ or gateways 104′ support the use of these various protocols 402-406. For example, the protocol 402 can be used to communicate with legacy controllers 102, the protocol 404 can be used to communicate with higher-level components such as the components 118-120, and the protocol 406 can be used to communicate with higher-level components such as the components 112-116.

Note that there are a wide variety of ways in which these protocols can be used. For example, in a first approach, emulations of HIWAY algorithms or other legacy algorithms can be created in an advanced controller 110 that present data and messaging consistent with original HIWAY or other legacy objects. In a second approach, HIWAY or other legacy algorithms can be ported to an advanced controller 110, and the re-hosted algorithms can present their original data and messages just as they did on the legacy network. In a third approach, translation functionality can be supported by a junction gateway 104′ so that the gateway 104′ can receive data and messages native to the advanced controller 110 and present the data and messages in a format expected on the supervisory network 106.

Although FIGS. 2 through 4 illustrate one example of a gateway 104′ supporting migration from legacy devices to new devices and related details, various changes may be made to FIGS. 2 through 4. For example, the functional division shown in FIG. 2 is for illustration only. Various components in FIG. 2 could be combined, further subdivided, moved, or omitted and additional components could be added according to particular needs. As a particular example, the processing device 214 and memory 216 could be placed onto the same PCB card or other substrate as one, some, or all interfaces 204-208. Also, the specific protocols and use cases shown in FIGS. 3 and 4 are examples only. The gateway 104′ could support the use of other or additional protocols, and the gateway 104′ could be used in any other suitable manner.

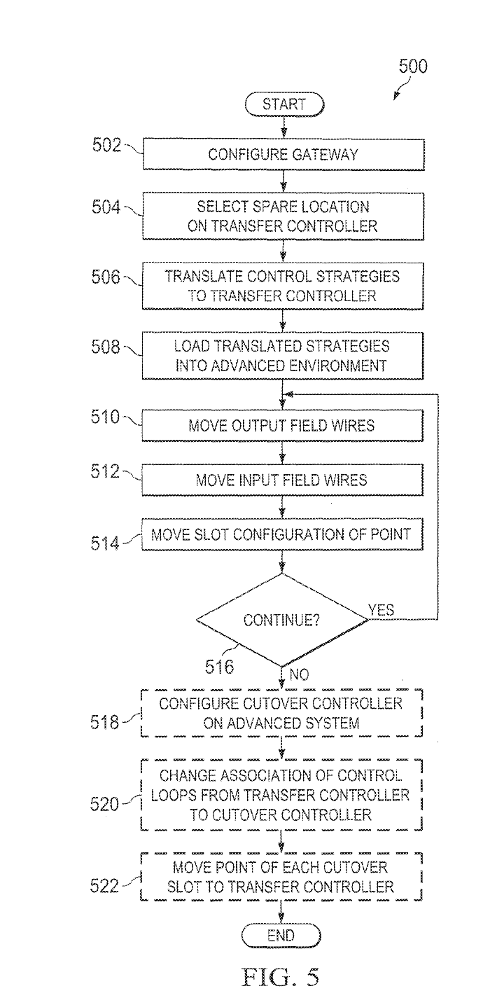

FIG. 5 illustrates an example method 500 for performing a point-by-point hot cutover from a legacy device to a new device in accordance with this disclosure. In this example, the method 500 is used to perform a cutover from a legacy controller 102 to an advanced controller 102′ without requiring a shutdown of part or all of a process system. For ease of explanation, the method 500 is described as being used with the gateway 104′ in the system 100 of FIG. 1. However, the method 500 could be used with any suitable gateway and in any suitable system. The method 500 could also be used to support migration between any other suitable devices.

During a hot cutover, the “points” configured in the legacy controller 102 are temporarily moved to the advanced controller 102′. However, the points are fully visible to plant control operations through existing operator displays. The points are subsequently moved to the appropriate emulated box at the end of the last control loop being migrated to an emulation. This enables a system operator to view and control the process from the legacy network during and after the cutover. During the cutover of each control loop, the control functions of other points remain undisturbed. This advantageously provides consistent access to the control system during the cutover using existing operator displays.

As a particular example of this functionality, the method 500 could be used to support a point-by-point hot cutover from one or more legacy HONEYWELL HIWAY devices (that are part of a Total Plant Network or “TPN”) to one or more HONEYWELL EXPERION C300 controllers (which can emulate HIWAY functions via the gateway 104′). The hot cutover is achieved by moving physical box slots point-by-point to the C300 environment. Field device connections are also moved from the HIWAY devices to Series C inputs/outputs (IOs) of the C300 controllers one by one. This procedure enables the distribution of the points across physical HIWAY devices and the emulated HIWAY devices of the C300. TPN custom graphics can access process and control data from both physical and emulated points without any apparent difference to the operator.

As shown in FIG. 5, a gateway is configured at step 502. This could include, for example, personnel configuring a gateway 104′ that connects Level 2 applications and devices to Level 1 controllers. A mechanism can be configured in the gateway 104′ to mimic or emulate control functions of legacy controllers 102 on advanced controllers 102′, thus preserving the point “footprint” on the legacy control system while the points are actually running on the advanced control system. In some embodiments, this may include configuring an EXPERION HIWAY bridge that includes emulation strategies running in a C300 controller, where the emulation strategies link control strategies of the C300 controller to legacy HIWAY gateway (HG) points. This may also include configuring a supervisory interface 204, such as a K4LCN interface card, which channelizes communications to physical HIWAY devices and emulated HIWAY devices running on C300 controllers in order to provide a uniform TPN view. This may further include configuring an advanced network interface 208, such as an EHBI, which connects the HG to C300 controllers on the FTE network.

One or more spare (unused) locations on the advanced controller are selected on which to migrate at least one point at step 504. Here, the advanced controller 102′ is referred to as a “transfer controller,” while the legacy controller 102 is referred to as a “cutover controller.” In some embodiments, selecting one or more spare locations may include the gateway selecting or identifying one or more spare slot addresses on the HG where the device being cutover resides. The spare slot address can be on a spare box address available on the HG or on the basic control box that is already running on the C300. It is assumed that a spare box address is available on the HG. In some embodiments, a basic control may be configured on the FTE network in the spare box address available on the HG, and the emulation may be configured and loaded for the transfer controller. This configuration step may be skipped if a spare slot address of a basic control is already emulated and running on the C300.

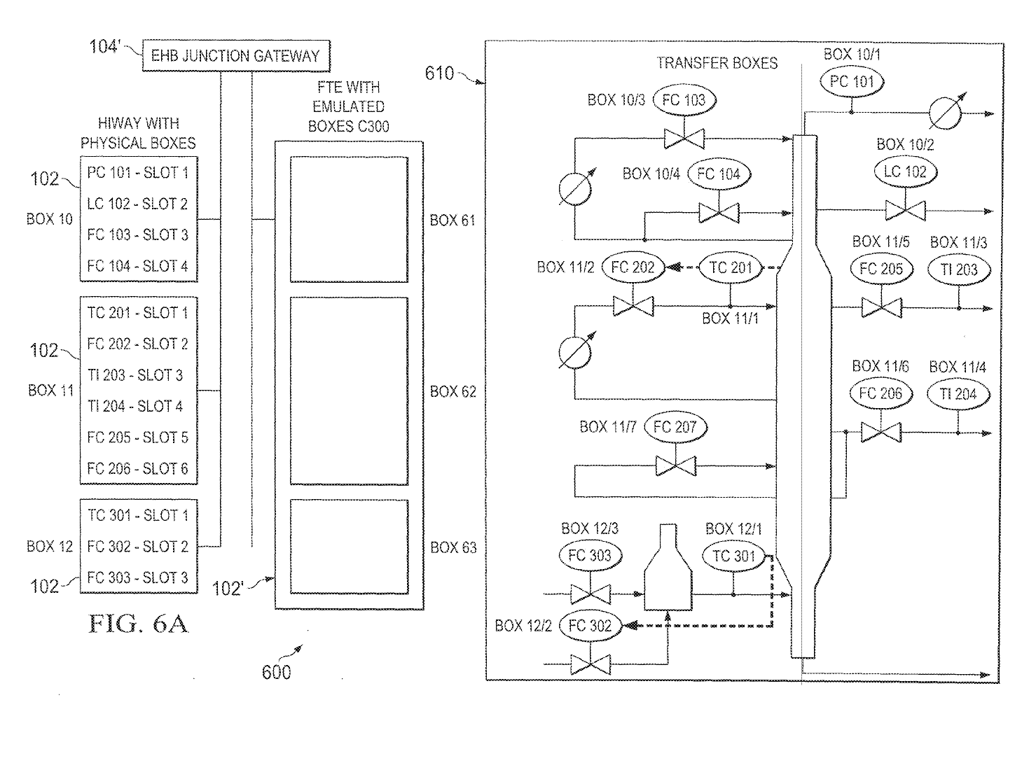

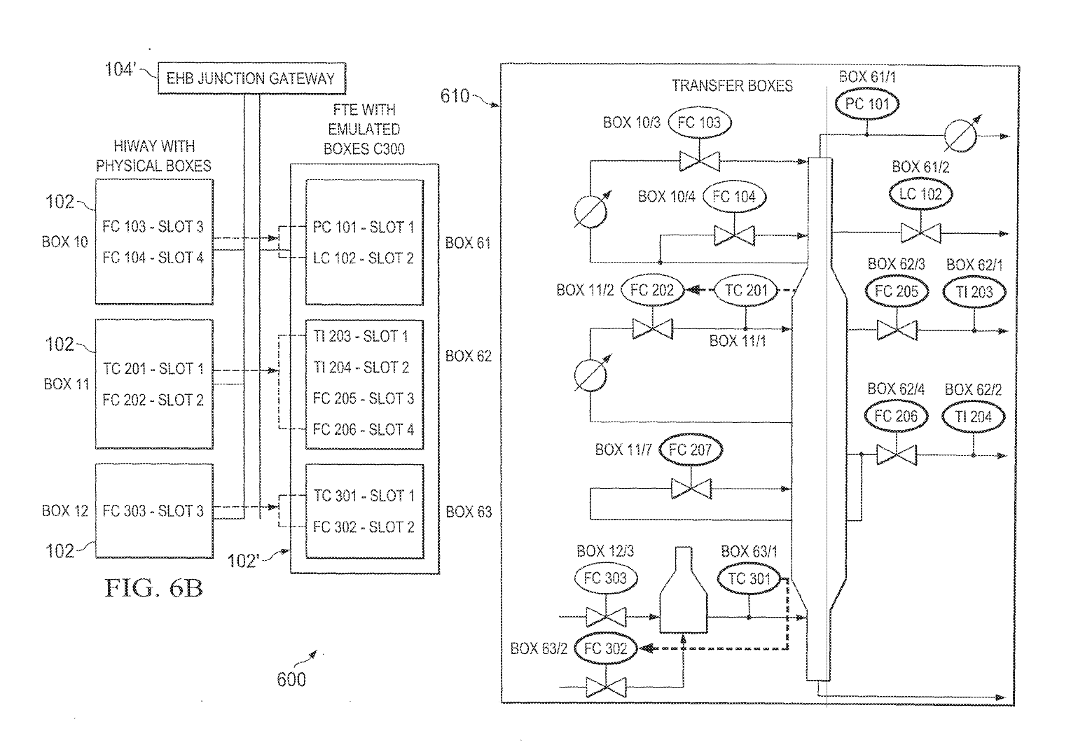

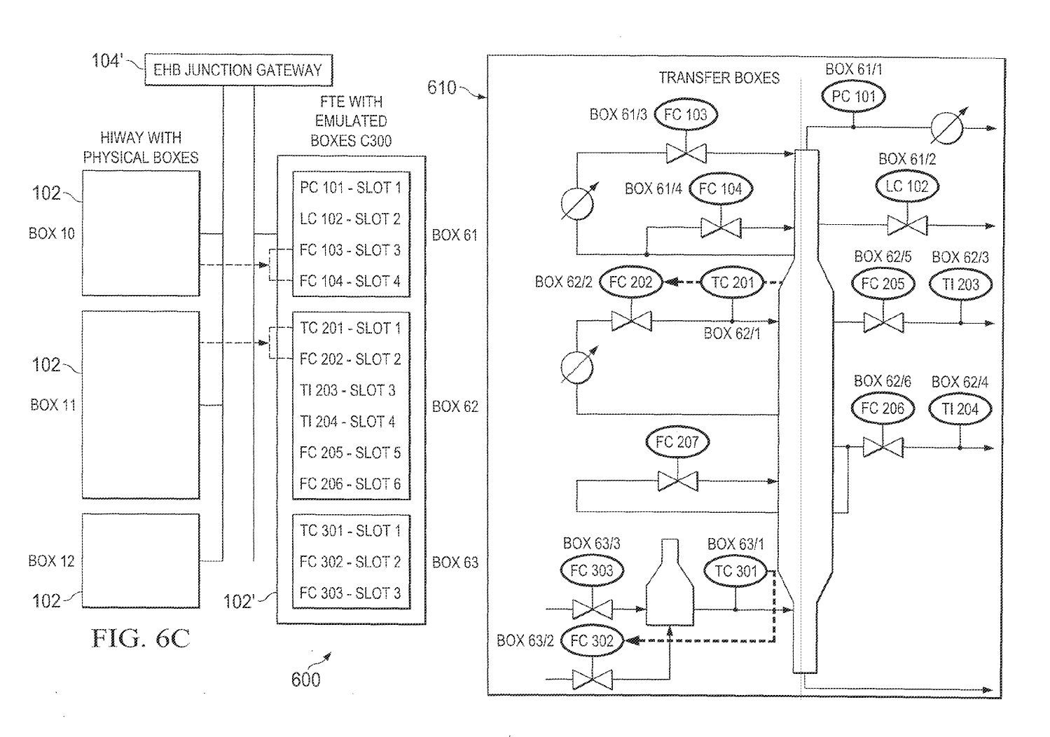

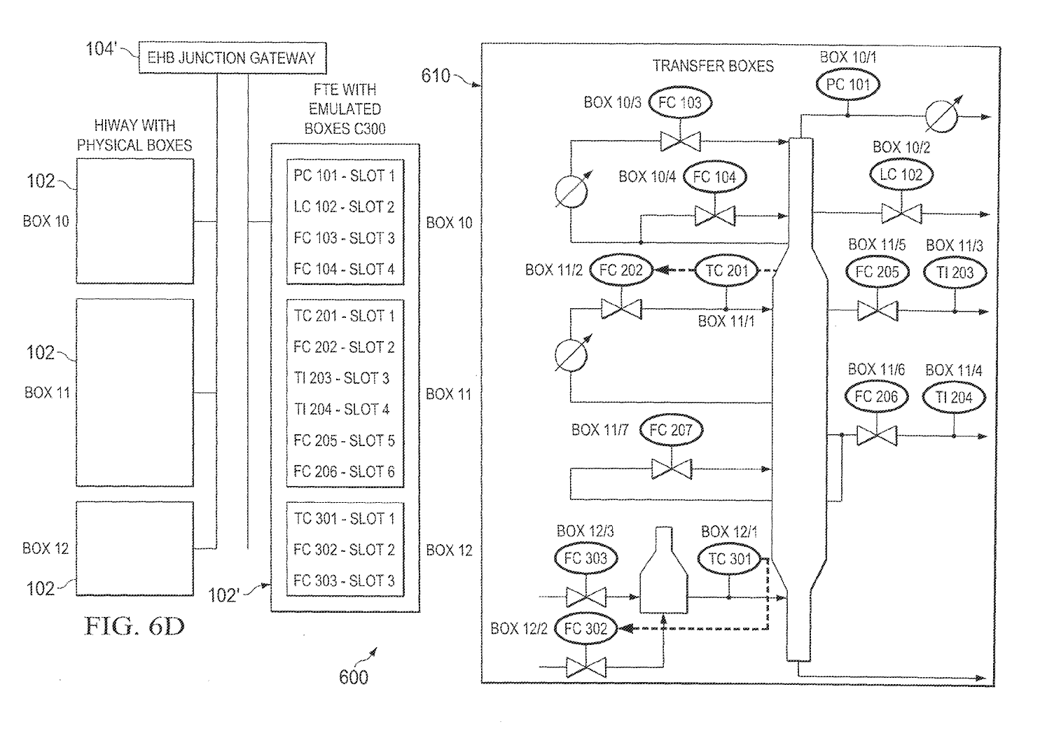

As an example of step 504, FIG. 6A depicts a system 600 and corresponding graphical display 610 at an operator workstation. As shown in FIG. 6A, the system 600 includes a gateway 104′ that is coupled to a plurality of legacy controllers 102 and an advanced controller 102′. The legacy controllers 102 are identified by a box address, such as Box 10, Box 11, or Box 12. Each legacy controller 102 includes a plurality of points, and each point has a slot address, such as ‘PC 101’ or ‘TC 301’. Each of the points on the legacy controllers 102 is associated with a graphical object in the graphical display 610. For example, point ‘PC 101’ associated with Box 10 and slot 1 is depicted in the upper right corner of the graphical display 600 as indicated by the large arrow. In step 504, a plurality of spare box addresses on the advanced controller 102′ are identified by the gateway 104′. As shown in FIG. 6A, the spare box addresses are Box 61, Box 62, and Box 63. Because control of the system 600 is still associated with the legacy controllers 102, Boxes 61-63 are currently unused, and the graphical display 600 depicts addresses only from Box 10, Box 11, and Box 12.

Control strategies of the cutover controller are translated to equivalent strategies to be run on the transfer controller at step 506. This may include, for example, the gateway translating HIWAY strategies of the cutover controller to equivalent C300 strategies using a translator tool. The translated C300 strategies can include one or more emulation function blocks that enable the LCN HG to access EXPERION regulatory function block parameters. The translated strategies are loaded into an advanced control environment at step 508. This may include, for example, they gateway loading the translated strategies into the C300 environment. At this point, control is still performed on the cutover controller.

The control system is now prepared to take a control loop out of legacy control. Field wires of the control loop's output(s) are moved to corresponding output(s) on the advanced control system at step 510. This may include, for example, a technician or engineer moving the field wires of the slot output(s) from the legacy controller to the corresponding C300 series C output(s). An operator's view into a process (including operator applications and any custom graphics) is still available on the legacy control system (such as the TPN) since the input(s) on the control loop is/are still intact on the cutover controller. However, the output(s) can be controlled from the advanced control system (such as the EXPERION control system).

Field wires of the control loop's input(s) are moved to corresponding input(s) on the advanced control system at step 512. This may include, for example, a technician or engineer moving the field wires of the slot input(s) to corresponding C300 series C input(s). The operator's view into the process (including the operator applications and custom graphics) is now available on the advanced control system.

The slot configuration of the point of the control loop is moved from the cutover controller to the transfer controller at step 514. This may include, for example, the gateway changing the box address of the point and loading with a HG Only option. This restores the operator's view to the control loop that is now running on the advanced control environment. The control loop cutover is now complete, and supervisory control (if present) can be cascaded on the control loop.

To illustrate, FIG. 6B depicts the system 600 and the graphical display 610 after some of the slots have been cut over to the advanced controller 102′. As indicated by the dashed arrows, some of the slots in Boxes 10-12 have been cut over to the corresponding Boxes 61-63. Likewise, in the graphical display 610, the box addresses have changed on the corresponding graphical object, indicating that a particular slot has been moved from the legacy controller 102 to the advanced controller 102′. For example, point ‘PC 101’ is now associated with Box 61, slot 1 as indicated by the large arrow. However, the operator's graphical display 610 remains the same (except for the changed box addresses), and the operator's ability to control the system 600 and associated processes also remains the same.

A decision is made whether there are additional control loops associated with the cutover controller at step 516. If so, the process returns to step 510, and steps 510-514 can be repeated for each additional control loop. If not (meaning field wires for all control loops have been moved), the entire controller is now cut over from the existing control system to the advanced control system, and the cutover controller may now be operating as a backup or spare controller.

To illustrate, FIG. 6C depicts the system 600 and the graphical display 610 after all slots are cut over to the advanced controller 102′. In the system 600, all of the slots in Boxes 10-12 have been cut over to the corresponding Boxes 61-63. Likewise, in the graphical display 610, all of the box addresses have changed on the corresponding graphical objects, indicating that all of the slots have been moved from the legacy controller 102 to the advanced controller 102′.

At this point, emulated box addresses are still identified as Boxes 61-63. If this is acceptable to the operators, managers, control system, and any other relevant stakeholders, the method 500 may stop. However, in some systems, it may be desirable or necessary to change the emulated box addresses to the legacy box addresses. For example, in the system 600, it may be necessary to change the box addresses of Boxes 61-63 to Boxes 10-12, respectively. The following optional steps can therefore be performed to update the box addresses.

The cutover controller is configured on the advanced control system at step 518. This may include, for example, the gateway configuring and loading the emulation for the cutover controller on the advanced control system and moving the cutover controller to the advanced control system by using the network switch available on the standard system display. The controller association of the control loops is changed from the transfer controller to the cutover controller at step 520. This may include, for example, the gateway reloading the strategies if needed on the advanced control system. The point of each cutover slot is moved from the cutover controller to the transfer controller at step 522. For example, the gateway moves the point by changing the box address of the point and loading with an HG Only option. This restores the view to the slot that is now running on the advanced controller. The restoration of the slot to the original box address is now complete. Supervisory control (if present) can be cascaded on the slot. Step 522 can be repeated for each configured slot on the transfer controller. Once completed, the strategies of the transfer controller are completely restored to the original box address, and the originally spare box addresses (e.g., Boxes 61-63) are unused once again. Later, these spare box addresses on the transfer controller can be reused for a cutover of another controller. The spare box addresses can be reused repeatedly for each cutover as many times as needed to complete a full migration to the advanced control system.

To illustrate, FIG. 6D depicts the system 600 and the graphical display 610 after all box addresses are changed on the advanced controller 102′. In the system 600, Boxes 61-63 have been readdressed as Boxes 10-12. Likewise, in the graphical display 610, all of the box addresses have changed back to the original box addresses on the corresponding graphical objects.

Although FIG. 5 illustrates one example of a method 500 for performing a point-by-point hot cutover from a legacy device to a new device, various changes may be made to FIG. 5. For example, while shown as a series of steps, various steps in FIG. 5 could overlap, occur in parallel, occur in a different order, or occur any number of times. Additionally, while the method 500 has been described with respect to controllers in a process control system, the method 500 may also be used for any other suitable devices.

Using the techniques described above, legacy controllers can be replaced with advanced controllers in an incremental point-by-point manner, allowing engineers and operators to switch to advanced system views and control at their convenience. This is in contrast to moving all control loops and their corresponding wires all at once. In an “all at once” cutover, there is inevitably greater system downtime involved. Also, operators may need to temporarily use alternative control methods during the cutover. Likewise, the number of updates and physical wire moves required at the same time increases the possibility of error.

In the point-by-point cutover disclosed above, engineers and operators can continue using existing legacy views, supervisory controls, and system displays (including native windows and GUI displays, supervisory control strategies, applications, custom graphics, and other configuration) while replacement of legacy devices with advanced devices takes place. Production losses during such a switchover are minimized greatly if not eliminated totally. Later, a switchover to a total advanced network and decommissioning of the legacy systems and components can occur at a convenient point. Moreover, the migration can be spread across multiple controllers, thus enabling a unit-wise cutover process rather than a controller-wise cutover. In addition, the disclosed cutover process involves reduced or minimal risk since all other process parameters remain under control except for the particular slot being cutover (and only during the time of the actual cutover). The overall migration can span a long duration with process control stability tested at each point cutover, which enables staggering of investments and resources as well.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit” and “receive,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
translating at least one control strategy associated with a first controller into an equivalent translated control strategy compatible with a second controller, wherein the first and second controllers represent controllers in an industrial process control and automation system;
selecting one or more spare locations on the second controller to configure one or more corresponding points;
loading the at least one translated control strategy into a control environment associated with the second controller; and
moving a slot configuration of each of the one or more points from the first controller to the second controller.

2. The method of claim 1, wherein:
the first controller comprises a legacy controller;
the second controller comprises an advanced controller; and
the first controller and the second controller are connected to a junction gateway.

3. The method of claim 1, further comprising:
performing the selecting, translating, loading, and moving operations while providing continuous operator control and view of an industrial process associated with the industrial process control and automation system.

4. The method of claim 1, wherein moving the slot configuration comprises changing a box address of each point to a box address associated with the corresponding spare location.

5. The method of claim 1, wherein the slot configuration of each point is moved after field wires associated with the point are physically moved from the first controller to the second controller.

6. The method of claim 2, further comprising:
configuring the junction gateway with one or more emulation strategies to link the at least one translated control strategy to one or more points of the first controller.

7. The method of claim 1, further comprising:
updating one or more box addresses associated with the one or more spare locations on the second controller to match one or more corresponding box addresses associated with the first controller.

8. The method of claim 1, wherein the at least one translated control strategy comprises at least one emulation function block that enables access to function block parameters associated with the second controller.

9. An apparatus comprising:
a first interface configured to communicate with a first controller in an industrial process control and automation system;
a second interface configured to communicate with a second controller in the industrial process control and automation system; and
at least one processing device configured to:
select one or more spare locations on the second controller to configure one or more corresponding points;
translate at least one control strategy associated with the first controller into an equivalent translated control strategy compatible with the second controller;
load the at least one translated control strategy into a control environment associated with the second controller; and
move a slot configuration of each of the one or more points from the first controller to the second controller.

10. The apparatus of claim 9, wherein:
the first interface is configured to communicate with a legacy controller; and
the second interface is configured to communicate with an advanced controller.

11. The apparatus of claim 9, wherein the at least one processing device is further configured to perform the select, translate, load, and move operations while providing continuous operator control and view of an industrial process associated with the industrial process control and automation system.

12. The apparatus of claim 9, wherein the at least one processing device is configured to move the slot configuration by changing a box address of each point to a box address associated with the corresponding spare location.

13. The apparatus of claim 9, wherein the at least one processing device is configured to move the slot configuration of each point after field wires associated with the point are physically moved from the first controller to the second controller.

14. The apparatus of claim 9, wherein the at least one processing device is further configured with one or more emulation strategies to link the at least one translated control strategy to one or more points of the first controller.

15. The apparatus of claim 9, wherein the at least one processing device is further configured to update one or more box addresses associated with the one or more spare locations on the second controller to match one or more corresponding box addresses associated with the first controller.

16. The apparatus of claim 9, wherein the at least one translated control strategy comprises at least one emulation function block that enables access to function block parameters associated with the second controller.

17. A non-transitory computer readable medium embodying a computer program, the computer program comprising computer readable program code for:
translating at least one control strategy associated with a first controller into an equivalent translated control strategy compatible with a second controller, wherein the first and second controllers represent controllers in an industrial process control and automation system;
selecting one or more spare locations on the second controller to configure one or more corresponding points;
loading the at least one translated control strategy into a control environment associated with the second controller; and
moving a slot configuration of each of the one or more points from the first controller to the second controller.

18. The computer readable medium of claim 17, wherein the computer readable program code for moving the slot configuration comprises computer readable program code for changing a box address of each point to a box address associated with the corresponding spare location.

19. The computer readable medium of claim 17, wherein the computer program further comprises computer readable program code for:
providing continuous operator control and view of an industrial process associated with the industrial process control and automation system.

20. The computer readable medium of claim 17, wherein the computer program further comprises computer readable program code for:
updating one or more box addresses associated with the one or more spare locations on the second controller to match one or more corresponding box addresses associated with the first controller.
